(19) United States
(12) Patent Application Publication
(10) Pub. No.: US 2010/0282278 A1
(43) Pub. Date: Nov. 11, 2010

(54) EXPOSURE APPARATUS, CLEANING METHOD, AND DEVICE MANUFACTURING METHOD

(75) Inventor: Tsuyoshi Arai, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/770,469

(22) Filed: Apr. 29, 2010

(30) Foreign Application Priority Data
May 7, 2009 (JP) 2009-112644

(51) Int. Cl. B08B 3/00

(52) U.S. Cl. 134/26; 134/94.1

(57) ABSTRACT

The exposure apparatus of the present invention includes a cleaning nozzle that discharges a cleaning liquid or a rinsing liquid so as to clean a member that forms a space between a end surface of the projection optical system and a surface of the substrate stage facing the end surface and clean a member that is present in the space, a cleaning liquid supply unit configured to supply the cleaning liquid to the cleaning nozzle, a rinsing liquid supply unit configured to supply the rinsing liquid to the cleaning nozzle, and a control unit configured to control the supply from the cleaning liquid supply unit and the rinsing liquid supply unit. The control unit carries out control such that the rinsing liquid is supplied successively with the discharge of the cleaning liquid before and after the discharge of the cleaning liquid from the cleaning nozzle.

### BACKGROUND OF THE INVENTION

1. Field of the Invention

The present invention relates to an exposure apparatus, a cleaning method, and a device manufacturing method.

2. Description of the Related Art

Conventionally, components for exposure apparatuses may be contaminated for various reasons. If contaminants move and enter into the exposure space, such contaminants may cause exposure failure. In particular, this exposure failure easily occurs in the case of an immersion exposure apparatus in which liquid is filled in a space between a projection optical system and a substrate for exposure.

For dirt on the surfaces of a member that forms the exposure space inside the exposure apparatus and a member that is present in the exposure space, e.g., a projection optical system, an immersion liquid supply-recovery nozzle, a substrate stage top plate, and the like, a cleaning liquid is discharged from an immersion liquid supply-recovery nozzle or a dedicated cleaning nozzle for cleaning dirt. Japanese Patent Laid-Open No. 2006-523031 discloses an immersion exposure apparatus that selectively supplies an immersion liquid and a cleaning liquid through the intervention of a switch valve since the immersion exposure apparatus also supplies the cleaning liquid using an immersion liquid supply-recovery nozzle.

However, in the immersion exposure apparatus disclosed in Japanese Patent Laid-Open No. 2006-523031, the behavior of the cleaning liquid to be discharged is not stabilized if air is introduced into a pipe for supplying the cleaning liquid when the cleaning liquid is discharged from the immersion liquid supply-recovery nozzle so as to clean the members. Consequently, the cleaning liquid may become in the form of mist or foam, resulting in splashing of the cleaning liquid throughout the surrounding area. In particular, if a switch valve is selectively switched, the switching of supply from the immersion liquid to the cleaning liquid is performed intermittently, whereby air is easily introduced.

### SUMMARY OF THE INVENTION

In view of the foregoing, the present invention provides an exposure apparatus and a cleaning method that can reduce splashing of a cleaning liquid, when a member constituting the exposure space inside the exposure apparatus and a member that is present in the exposure space are cleaned by discharging the cleaning liquid.

According to an aspect of the present invention, there is provided an exposure apparatus that projects a pattern of an original onto a substrate held by a substrate stage via a projection optical system, the exposure apparatus including a cleaning nozzle that discharges a cleaning liquid or a rinsing liquid so as to clean a member that forms a space between an end surface of the projection optical system and a surface of the substrate stage facing the end surface and to clean a member that is present in the space, a cleaning liquid supply unit configured to supply the cleaning liquid to the cleaning nozzle, a rinsing liquid supply unit configured to supply the rinsing liquid to the cleaning nozzle, and a control unit configured to control the supply from the cleaning liquid supply unit and the rinsing liquid supply unit, wherein the control unit carries out control such that the rinsing liquid is supplied successively with the discharge of the cleaning liquid before and after the discharge of the cleaning liquid from the cleaning nozzle.

According to another aspect of the present invention, there is provided a cleaning method for cleaning a member that forms a space between an end surface of the projection optical system in an exposure apparatus and a surface of a substrate stage facing the end surface by conducting discharge of a cleaning liquid and a rinsing liquid from a cleaning nozzle, the cleaning method including supplying the rinsing liquid from the cleaning nozzle, supplying the cleaning liquid from the cleaning nozzle successively after the rinsing liquid is supplied, and supplying the rinsing liquid from the cleaning nozzle successively after the supply of the cleaning liquid.

According to the present invention, when cleaning for a member constituting the exposure space inside the exposure apparatus and a member that is present in the exposure space is performed, splashing of the cleaning liquid can be reduced.

Further features of the present invention will become apparent from the following description of exemplary embodiments with reference to the attached drawings.

### BRIEF DESCRIPTION OF THE DRAWINGS

FIG. 1 is a schematic diagram illustrating the configuration of the immersion exposure apparatus of the present invention.

FIG. 2 is a diagram illustrating an immersion liquid supply-recovery nozzle.

FIG. 3 is a schematic diagram illustrating the configuration of the exposure apparatus according to a first embodiment of the present invention.

FIG. 4 is a schematic diagram illustrating a variant example of the exposure apparatus of the first embodiment.

FIG. 5 is a schematic diagram illustrating the configuration of the exposure apparatus according to a second embodiment of the present invention.

FIG. 6 is a schematic diagram illustrating a variant example of the exposure apparatus of the second embodiment.

### DESCRIPTION OF THE EMBODIMENTS

Hereinafter, preferred embodiments of the present invention will now be described with reference to the attached drawings.

### First Embodiment

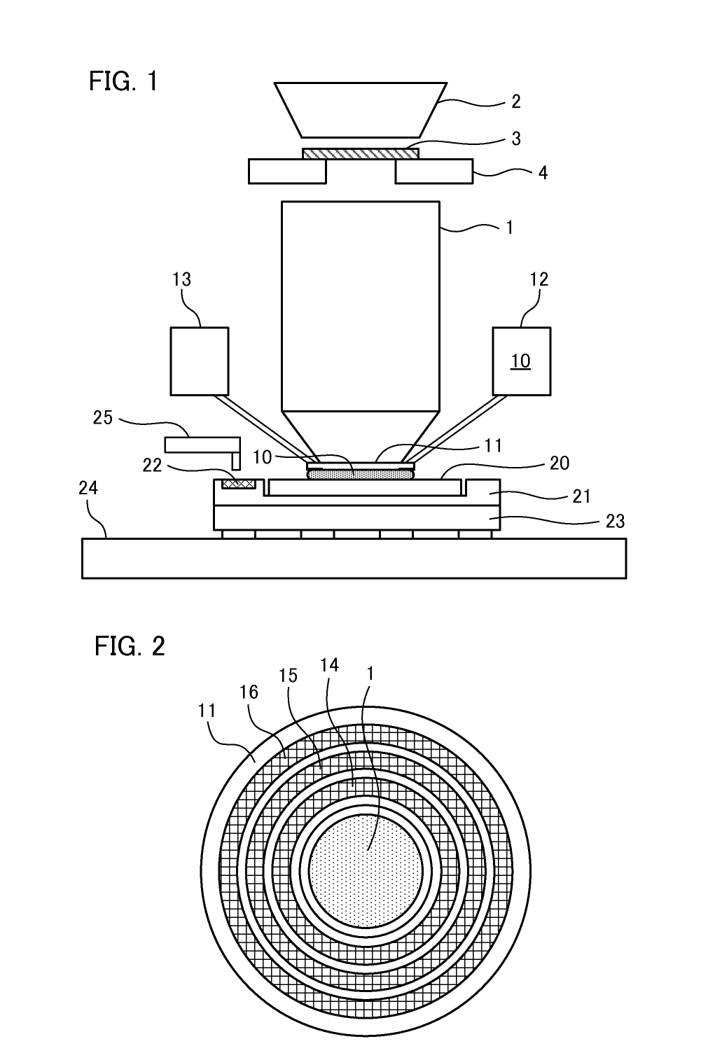

FIG. 1 is a schematic diagram illustrating the configuration of the immersion exposure apparatus according to a preferred embodiment of the present invention. In FIG. 1, an illumination optical system 2 illuminates a part of an original (mask) 3 using light provided from an exposure light source (not shown). During the time that the illumination optical system 2 is illuminating the mask 3, a mask stage 4 and a substrate stage 23 perform scanning-drive synchronously. With the synchronous drive, a desired overall pattern formed on the mask 3 is successively imaged on a substrate 20 held by the substrate stage 23 via a projection optical system 1 so as to expose the resist applied on the surface of the substrate 20.

An immersion liquid supply-recovery nozzle 11 is disposed between the end surface of the projection optical system 1 and the substrate 20. At this time, the immersion liquid supply-recovery nozzle 11 is disposed at a constant distance from the substrate 20 and the substrate stage top plate 21. The immersion liquid supply-recovery nozzle 11 supplies an immersion liquid 10 from an immersion liquid supply device 12 via a pipe. In addition, the immersion liquid supply-recovery nozzle 11 recovers the immersion liquid 10 in an immersion liquid recovery device 13 via a pipe. For immersion exposure, the immersion liquid is supplied and recovered, so that the liquid is controlled so as to be constantly interpose between the end surface of the projection optical system 1 and the substrate 20. Note that pure water is generally used for the immersion liquid 10.

The substrate stage top plate 21 is provided with a measurement mark 22 in which a mark for alignment and calibration measurement performed by a measuring mechanism 25 is disposed. The substrate stage 23 moves over a substrate stage plate 24 so as to perform an exposure operation and measurement of the measurement mark 22. At this time, since the immersion liquid 10 may be present outside of the substrate 20, the substrate stage top plate 21 and the measurement mark 22 are configured such that the their height is substantially the same as (flush with) that of the substrate 20 held by the substrate stage 23.

For the immersion exposure apparatus, a member that forms an exposure space (liquid immersion region) and a member that is present in the exposure space may be contaminated for various reasons. If such contaminants permeate into the exposure space, it becomes a cause of exposure failure. Examples of such contaminants include particles attached to the substrate 20 to be carried into the exposure apparatus, and peeled pieces of the resist or top coat. In addition, particles that float in the internal space of the apparatus, contaminants attached when the apparatus is installed and assembled, and particles attached during the long-term stoppage of the apparatus are also contemplated. Exemplary impurities which contaminate the substrate stage top plate 21 include organic substances, inorganic substances, and the like that are present in the gas in the apparatus internal space. Furthermore, photo-decomposition of the resist and the top coat dissolved in the immersion liquid 10, organic substances or inorganic substances originally contained in the immersion liquid 10, and the like are also contemplated.

The immersion liquid supply-recovery nozzle 11 and a dedicated cleaning nozzle clean dirt on the surfaces of the projection optical system 1, the immersion liquid supply-recovery nozzle 11, and the substrate stage top plate 21 by discharging a cleaning liquid. Examples of such cleaning liquid include surfactants, solvents, functional water, and the like.

As shown in FIG. 2, the immersion liquid supply-recovery nozzle 11 is provided with a liquid supply port 14 and a liquid recovery port 15 such that they are disposed around the periphery of the projection optical system 1. Furthermore, a cleaning liquid recovery port 16 is provided at the outer periphery thereof.

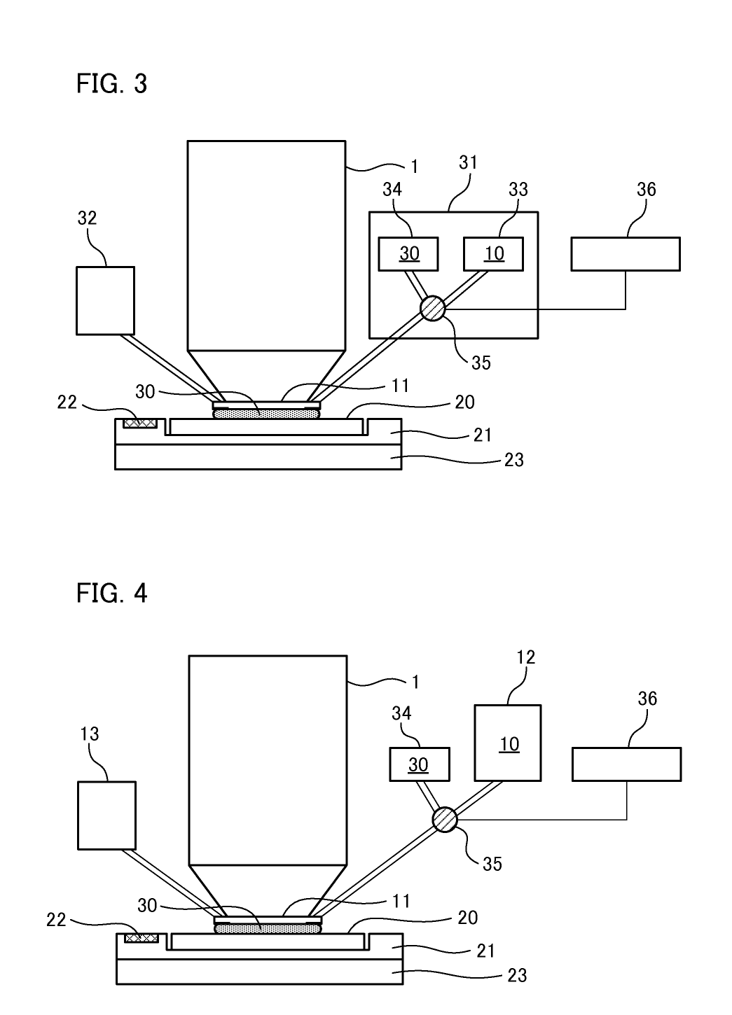

Hereinafter, the cleaning method of the present embodiment will now be described with reference to FIG. 3. When implementing cleaning, the substrate 20 subjected to hydrophobic coating of a fluorine resin and the like is mounted on the substrate stage 23. At this time, the substrate stage 23 on which the substrate 20 is mounted is moved under the immersion liquid supply-recovery nozzle 11.

A cleaning liquid 30 is supplied from a cleaning liquid supply device 31 to the immersion liquid supply-recovery nozzle 11. The pipe for supplying the cleaning liquid 30 and the nozzle for discharging the cleaning liquid 30 may include a dedicated pipe and a cleaning nozzle for supplying the cleaning liquid 30, respectively, or may be shared as the pipe for supplying the immersion liquid 10 and the immersion liquid supply-recovery nozzle 11, respectively. In the present embodiment, the pipe and the nozzle are shared. With this arrangement, the number of parts and cost decrease, as well as a wider range of space around the immersion liquid supply-recovery nozzle can be ensured.

The supplied cleaning liquid 30 is discharged from the liquid supply port 14 of the immersion liquid supply-recovery nozzle 11 so as to fulfill the space formed by the projection optical system 1, the substrate 20, the substrate stage top plate 21, and the immersion liquid supply-recovery nozzle 11. The cleaning liquid 30 filling the space is recovered from the cleaning liquid recovery port 16 by a cleaning liquid recovery unit 32. Chemical action of the cleaning liquid 30 and physical action of the flow of the cleaning liquid 30 clean the surface of the projection optical system 1, the substrate stage top plate 21, or the immersion liquid supply-recovery nozzle 11.

A rinsing liquid supply section (rinsing liquid supply unit) 33 and a cleaning liquid supply section (cleaning liquid supply unit) 34 are provided inside the cleaning liquid supply device 31, and the supply pipe for the cleaning liquid 30 is confluent with the supply pipe for the rinsing liquid. A switching valve 35 is disposed at the confluent junction at which the flow path can be switched. By controlling the switching valve 35 by a control section (control unit) 36, the rinsing liquid and the cleaning liquid 30 can be successively switched (adjust the flow-rate ratio).

After cleaning has taken place, the switching valve 35 is controlled by the control section 36 so as to successively supply the rinsing liquid from the supply section for supplying the cleaning liquid 30 to the immersion liquid supply-recovery nozzle 11. After sufficient rinsing has taken place, supply of the rinsing liquid is stopped and rinsing is completed. Note that pure water is generally used as the immersion liquid 10 for immersion exposure. Hence, if pure water is used as the rinsing liquid, supply of the rinsing liquid to flow after cleaning by the use of the cleaning liquid 30 and supply of the immersion liquid 10 for performing immersion exposure can be successively performed, whereby the operation can be performed efficiently. Hereinafter, a description will be given for the case in which the immersion liquid 10 is assumed to be a rinsing liquid 10, depending on the application as appropriate.

The cleaning liquid 30 is supplied from the cleaning liquid supply device 31 to the immersion liquid supply-recovery nozzle 11. If supply of the cleaning liquid 30 is started with air being trapped inside the cleaning liquid supply pipe, the cleaning liquid 30 is discharged from the liquid supply port 14 of the immersion liquid supply-recovery nozzle 11 in the state of a gas-liquid mixture. The cleaning liquid 30, which has been discharged in the state of a gas-liquid mixture, may become in the form of fine liquid drops and be splashed throughout the surrounding area. In particular, if any surfactant is used as the cleaning liquid 30, foam may occur, resulting in frequent occurrence of splashing of the liquid drops.

For this reason, when the cleaning liquid 30 is supplied to the immersion liquid supply-recovery nozzle 11, the switching valve 35 provided inside the cleaning liquid supply device 31 is controlled by the control section 36 before the cleaning liquid 30 is supplied, and then the rinsing liquid 10 is supplied to the immersion liquid supply-recovery nozzle 11. After air is expelled from the supply pipe by supplying the rinsing liquid 10, the switching valve 35 is switched so as to successively supply the cleaning liquid 30. In other words, the rinsing liquid 10 is firstly discharged from the liquid supply port 14 of the immersion liquid supply-recovery nozzle 11, and then the cleaning liquid 30 is successively discharged therefrom. Consequently, the cleaning liquid 30 and air trapped in the pipe are not in direct contact with each other, and hence the cleaning liquid 30 and air do not become in the state of a gas-liquid mixture, whereby stable supply of the cleaning liquid 30 can be started.

If the supply of the cleaning liquid 30 is stopped immediately after completion of cleaning, air may be mixed into the cleaning liquid 30 remaining in the supply pipe for the cleaning liquid 30. If the rinsing liquid 10 is supplied to the immersion liquid supply-recovery nozzle 11 under this state, the cleaning liquid and air are discharged in the state of a gas-liquid mixture before the rinsing liquid 10 is discharged from the liquid supply port 14, whereby the exposure space may be contaminated due to splashing of liquid drops as described above.

For this reason, when the rinsing liquid 10 is supplied after the supplying of the cleaning liquid 30, the switching valve 35 is controlled by the control section 36 such that air is not trapped in the pipe for supplying the cleaning liquid 30, and the supply of the cleaning liquid 30 is successively switched to the supply of the rinsing liquid 10. Consequently, direct contact of the cleaning liquid 30 with air trapped in the pipe can be avoided, whereby discharge of the cleaning liquid 30 in the state of a gas-liquid mixture can be prevented.

With the aid of the switching valve 35, the control section 36 can control the concentration of the cleaning liquid 30 by adjusting the mixing ratio of the cleaning liquid 30 and the rinsing liquid 10. In this case, first, the rinsing liquid 10 only is supplied. Then, the flow rate of the cleaning liquid 30 is progressively increased while the flow rate of the rinsing liquid 10 is progressively decreased, so that the cleaning liquid is supplied while changing the concentration of the cleaning liquid by mixing it with the rinsing liquid 10. After completion of cleaning with the cleaning liquid 30, the switching valve 35 is controlled by the control section 36. This time, the flow rate of the cleaning liquid 30 is progressively decreased while the flow rate of the rinsing liquid 10 is progressively increased. With this arrangement, the concentration of the cleaning liquid 30 can be progressively changed. Hence, supplying the cleaning liquid 30 in the state of a gas-liquid mixture can be avoided, while the cleaning liquid 30 can be set to a predetermined concentration depending on the degree of dirt.

Also, the cleaning liquid supply section 34 may be composed of a storage tank (not shown) having a replaceable structure that will contain the highly-concentrated cleaning liquid 30. The highly-concentrated cleaning liquid 30 to be supplied from the storage tank may be diluted by mixing it with the rinsing liquid 10 by controlling the switching valve 35 at the control section 36 for supply. In general, pure water is readily available at semiconductor manufacturing factories, however, the cleaning liquid 30 contained in a tank is often purchased from outside suppliers for usage. Accordingly, if the cleaning liquid 30 is concentrated and stored in a readily replaceable storage tank (or cartridge), storage and replenishment of the cleaning liquid 30 can be readily attained. Furthermore, two or more of the respective switching valves 35, cleaning liquid supply sections 34, and storage tanks may be included such that the type of cleaning liquid can be changed depending on the degree of dirt.

While in the present embodiment, a description has been made of the case in which the cleaning liquid 30 is discharged from the liquid supply port 14 of the immersion liquid supply-recovery nozzle 11, the cleaning liquid 30 may be discharged from the liquid recovery port 15 of the immersion liquid supply-recovery nozzle 11. In addition, while a description has been made of the case in which the discharged cleaning liquid 30 is recovered from the cleaning liquid recovery port 16, the discharged cleaning liquid 30 may be recovered from either the liquid supply port 14 or the liquid recovery port 15.

As a variant example of the first embodiment described above, the rinsing liquid 10, i.e., the immersion liquid 10 may be supplied from the immersion liquid supply device 12 as shown in FIG. 4. Also, the cleaning liquid 30 may be recovered from the immersion liquid recovery device 13,

When cleaning is performed by the cleaning liquid 30, the control section 36 may stop supplying and recovering the cleaning liquid 30 for a prescribed time to allow it to stay. Also, when the cleaning liquid 30 is supplied, the flow rate may be dropped for moderate supply.

When cleaning is performed, plate and tray units instead of the substrate stage 23 may be conveyed under the immersion liquid supply-recovery nozzle 11 for cleaning. These units may be conveyed from the outside or may be included within the apparatus.

The members to be cleaned according to the present invention are a member that forms a space between the end surface of the projection optical system 1 and the substrate stage 23 facing the end surface, and a member that is present in the space. Thus, the end surface, the surface of the substrate stage 23, and the immersion liquid supply-recovery nozzle 11 are the objects to be cleaned. By driving the substrate stage 23, the surface of the substrate stage top plate 21 and the measurement mark 22 mounted on the substrate stage are also the objects to be cleaned.

While the present embodiment has been described for the cleaning mechanism of the immersion exposure apparatus, the present invention is not limited to the immersion exposure apparatus. Thus, the present invention may be used for the cleaning of the substrate stage top plate and the measurement mark of the conventional exposure apparatus in which the space between the projection optical system and the substrate is filled with gas.

Furthermore, the present invention can also be applied to the case where a plurality of the substrate stages is provided in the exposure apparatus. The top plates of a plurality of the substrate stages may be sequentially cleaned or simultaneously cleaned by arranging a plurality of cleaning units. It goes without saying that the stage to be cleaned is not limited to a stage for mounting a substrate, but may be a stage on which only a measurement mark is mounted and a stage having only a top plate.

Even in such a structure described above, when gas is introduced into the storage tank, gas may be present in the cleaning liquid 30 or before and after the supply of the cleaning liquid 30, which may cause the cleaning liquid 30 to be supplied in the state of a gas-liquid mixture. Hence, a gas detection sensor for detecting whether or not gas is present inside the pipe between the cleaning liquid supply section 34 and the switching valve 35 may be provided. If the gas detection sensor detects gas during the supply of the cleaning liquid 30, the detected signal is transmitted to the control section 36, and then the switching valve 35 is operated by the control section 36 so as to stop supplying the cleaning liquid 30. Alternatively, the cleaning liquid 30 may be flown backward and recovered.

### Second Embodiment

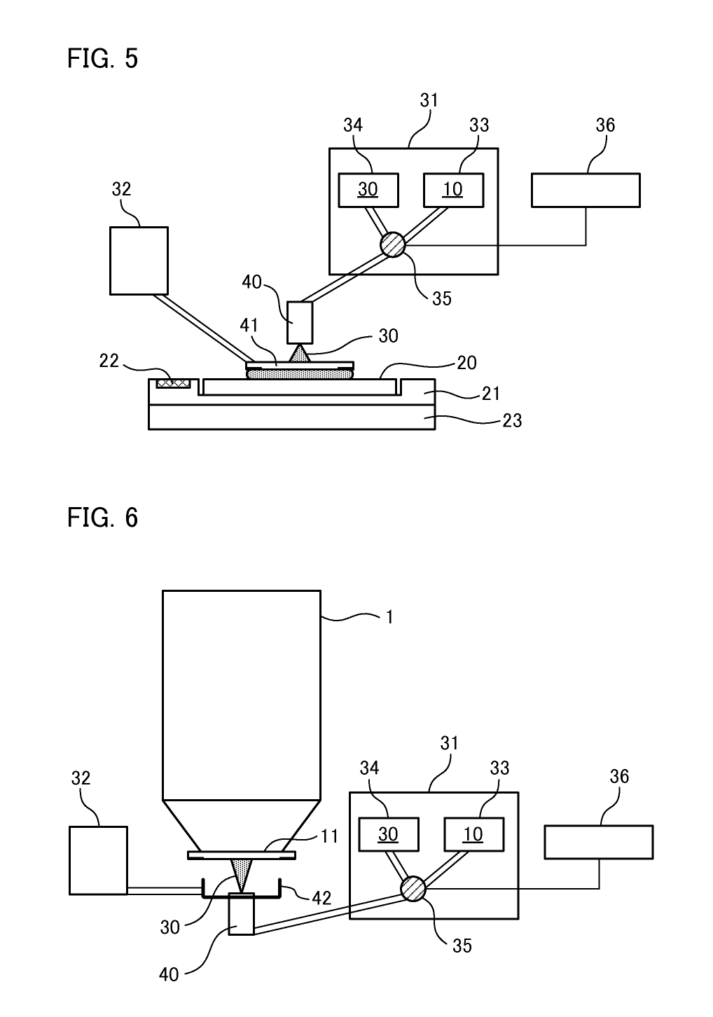

FIG. 5 is a schematic diagram illustrating the configuration of the exposure apparatus according to a second embodiment of the present invention. The discharge port of a cleaning nozzle 40 for discharging the cleaning liquid 30 is disposed facing to the substrate stage top plate 21. As in the first embodiment, the substrate 20 subjected to coating of a fluorine resin is mounted on the substrate stage 23. Here, the cleaning liquid 30 is supplied from the cleaning liquid supply device 31 to the cleaning nozzle 40. An annular cleaning liquid recovery nozzle 41 is arranged around the periphery of the cleaning nozzle 40. The discharged cleaning liquid 30 is recovered from the recovery port of the cleaning liquid recovery nozzle 41 to the cleaning liquid recovery unit 32.

In the present embodiment, the cleaning liquid 30 is ejected and discharged from the cleaning nozzle 40, whereby cleaning is performed by utilizing the impact forces and the physical forces associated with the flow of the liquid. With this arrangement, the surface of the substrate stage top plate 21 and the surface of the measurement mark 22 can be cleaned.

Since air is present inside the cleaning liquid supply pipe upon starting the supply of the cleaning liquid 30 to the cleaning nozzle 40, it is necessary to prevent the cleaning liquid 30 and air from being discharged from the cleaning nozzle 40 in the state of a gas-liquid mixture. For this reason, as in the first embodiment, when the supply of the cleaning liquid 30 is started, the switching valve 35 provided inside the cleaning liquid supply device 31 is controlled by the control section 36 such that the rinsing liquid 10 is first discharged from the cleaning nozzle 40, and then the cleaning liquid 30 is successively discharged therefrom.

When the rinsing liquid 10 is ejected after cleaning, the supply of the cleaning liquid 30 is successively switched to supply the rinsing liquid 10 by using the switching valve 35. Consequently, discharge of the cleaning liquid 30 in the state of a gas-liquid mixture can be prevented.

As a variant example of the second embodiment describe above, the cleaning nozzle 40 may be arranged at opposite position below the end surface of the projection optical system 1 or below the immersion liquid supply-recovery nozzle 11 as shown in FIG. 6. In this case, the discharge port of the cleaning nozzle 40 ejects the cleaning liquid 30 and the rinsing liquid 10 upward from below the end surface of the projection optical system 1 or from below the immersion liquid supply-recovery nozzle 11. The ejected cleaning liquid 30 and rinsing liquid 10 fall in drops below from the end surface of the projection optical system 1 or the immersion liquid supply-recovery nozzle 11. The cleaning liquid 30 and rinsing liquid 10 that have fallen downward may be received by a tray 42 disposed below the cleaning nozzle 40, and recovered from a drainage pipe connected to the tray 42 by the cleaning liquid recovery unit 32. It should be noted that the cleaning nozzle 40 may be extended from the outside to the inside of the exposure apparatus, or may be mounted on the substrate stage 23 or a transfer mechanism provided within the apparatus.

### (Device Manufacturing Method)

Next, a method of manufacturing a device (semiconductor device, liquid crystal display device, etc.) as an embodiment of the present invention is described. The semiconductor device is manufactured through a front-end process in which an integrated circuit is formed on a wafer, and a back-end process in which an integrated circuit chip is completed as a product from the integrated circuit on the wafer formed in the front-end process. The front-end process includes a step of exposing a wafer coated with a photoresist to light using the above-described exposure apparatus of the present invention, and a step of developing the exposed wafer. The back-end process includes an assembly step (dicing and bonding), and a packaging step (sealing). The liquid crystal display device is manufactured through a process in which a transparent electrode is formed. The process of forming a plurality of transparent electrodes includes a step of coating a glass substrate with a transparent conductive film having a photoresist deposited thereon, a step of exposing the glass substrate coated with the photoresist thereon to light using the above-described exposure apparatus, and a step of developing the exposed glass substrate. The device manufacturing method of this embodiment has an advantage, as compared with a conventional device manufacturing method, in at least one of performance, quality, productivity and production cost of a device.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-112644 filed May 7, 2009 which is hereby incorporated by reference herein in its entirety.

What is claimed is:

1. An exposure apparatus that projects a pattern of an original onto a substrate held by a substrate stage via a projection optical system, the exposure apparatus comprising:
a cleaning nozzle that discharges a cleaning liquid or a rinsing liquid so as to clean a member that forms a space between an end surface of the projection optical system and a surface of the substrate stage facing the end surface and clean a member that is present in the space;
a cleaning liquid supply unit configured to supply the cleaning liquid to the cleaning nozzle;
a rinsing liquid supply unit configured to supply the rinsing liquid to the cleaning nozzle; and
a control unit configured to control the supply of the cleaning liquid supply unit and the rinsing liquid supply unit,
wherein the control unit carries out control such that rinsing liquid is supplied successively with the discharge of the cleaning liquid before and after the discharge of the cleaning liquid from the cleaning nozzle.

2. The exposure apparatus according to claim 1, further comprising:
a recovery nozzle that recovers the cleaning liquid and the rinsing liquid discharged from the cleaning nozzle.

3. The exposure apparatus according to claim 1, further comprising:
a switching unit configured to switch a flow-rate ratio between the cleaning liquid to be supplied from the cleaning liquid supply unit and the rinsing liquid to be supplied from the rinsing liquid supply unit so as to supply both liquid to the cleaning nozzle,
wherein the control unit controls the flow rate of the rinsing liquid and the cleaning liquid via the switching unit so as to supply the rinsing liquid successively before and after the discharge of the cleaning liquid.

4. The exposure apparatus according to claim 3, wherein a cleaning liquid to be supplied from the cleaning liquid supply unit is a highly-concentrated cleaning liquid to be used after being diluted with the rinsing liquid, and the control unit controls the flow rate of the highly-concentrated cleaning liquid and the rinsing liquid with the aid of the switching unit so as to supply the cleaning liquid having a predetermined concentration to the cleaning nozzle.

5. The exposure apparatus according to claim 4, wherein the cleaning liquid supply unit comprises a storage unit configured to store the highly-concentrated cleaning liquid, and the storage unit is replaceable.

6. The exposure apparatus according to claim 3, further comprising:
a gas detection unit configured to detect whether or not gas is present in the cleaning liquid or before and after the discharge of the cleaning liquid in the course from the cleaning liquid supply unit to the switching unit,
wherein if the gas detection unit detects gas, the control unit controls the switching unit so as to stop the discharge of the cleaning liquid.

7. The exposure apparatus according to claim 1, further comprising:
an immersion liquid supply-recovery nozzle configured to supply and recover an immersion liquid in order to perform immersion exposure between the end surface of the projection optical system and the substrate with interposition of the immersion liquid,
wherein the cleaning nozzle discharges the cleaning liquid and the rinsing liquid to a space in which the immersion liquid is interposed.

8. The exposure apparatus according to claim 7, wherein the immersion liquid supply-recovery nozzle is shared as the cleaning nozzle and the recovery nozzle.

9. The exposure apparatus according to claim 7, wherein the immersion liquid is used as the rinsing liquid.

10. The exposure apparatus according to claim 1, wherein the cleaning nozzle has a discharge port that is disposed facing to the end surface of the projection optical system or the immersion liquid supply-recovery nozzle so as to discharge the cleaning liquid and the rinsing liquid from the discharge port toward the end surface of the projection optical system or the immersion liquid supply-recovery nozzle.

11. A cleaning method for cleaning a member that forms a space between an end surface of the projection optical system in an exposure apparatus and a surface of a substrate stage facing the end surface by conducting discharge of a cleaning liquid and a rinsing liquid from a cleaning nozzle, the cleaning method comprising the steps of:
supplying the rinsing liquid from the cleaning nozzle;
supplying the cleaning liquid from the cleaning nozzle successively after the rinsing liquid is supplied; and
supplying the rinsing liquid from the cleaning nozzle successively after the supply of the cleaning liquid.

12. The cleaning method according to claim 11,
wherein the cleaning liquid is a highly-concentrated cleaning liquid to be supplied after being diluted with the rinsing liquid,
wherein successive supply of the cleaning liquid is performed until a predetermined concentration is reached by progressively decreasing the flow rate of the rinsing liquid and by progressively increasing the flow rate of the highly-concentrated cleaning liquid, and
wherein successive supply of the rinsing liquid after the supply of the cleaning liquid is performed by progressively decreasing the flow rate of the cleaning liquid and by progressively increasing the flow rate of the rinsing liquid.

13. A device manufacturing method comprising the steps of:
exposing a substrate using an exposure apparatus that projects a pattern of an original onto the substrate held by a substrate stage via a projection optical system; and
developing the exposed substrate,
wherein the exposure apparatus comprises:
a cleaning nozzle that discharges a cleaning liquid or a rinsing liquid so as to clean a member that forms a space between an end surface of the projection optical system and a surface of the substrate stage facing the end surface and clean a member that is present in the space;
a cleaning liquid supply unit configured to supply the cleaning liquid to the cleaning nozzle;
a rinsing liquid supply unit configured to supply the rinsing liquid to the cleaning nozzle; and
a control unit configured to control the supply from the cleaning liquid supply unit and the rinsing liquid supply unit,
wherein the control unit carries out control such that the rinsing liquid is supplied successively with the discharge of the cleaning liquid before and after the discharge of the cleaning liquid from the cleaning nozzle.
